(19) United States
(12) Patent Application Publication
(10) Pub. No.: US 2015/0163008 A1
(43) Pub. Date: Jun. 11, 2015

(54) METHOD AND APPARATUS FOR CELL DISCOVERY

(71) Applicant: Electronics and Telecommunications Research Institute, Daejeon (KR)

(72) Inventors: Cheulsoon KIM, Daejeon (KR); Young Jo KO, Daejeon (KR); Sung-Hyun MOON, Daejeon (KR); Joonwoo SHIN, Daejeon (KR); Jae Young AHN, Daejeon (KR)

(21) Appl. No.: 14/562,422

(22) Filed: Dec. 5, 2014

(30) Foreign Application Priority Data
Dec. 6, 2013 (KR) 10-2013-0151678
Feb. 5, 2014 (KR) 10-2014-0013298
May 9, 2014 (KR) 10-2014-0055861
Jul. 28, 2014 (KR) 10-2014-0095849

(51) Int. Cl. H04J 11/00; H04L 5/00; H04W 48/16

(52) U.S. Cl. CPC H04J 11/0069; H04W 48/16; H04L 5/0048

(57) ABSTRACT

A terminal measures quality of a radio link by using at least one first orthogonal frequency division multiplexing (OFDM) symbol among OFDM symbols excluding an OFDM symbol including a channel state information (CSI)-reference signal (RS).

### CROSS-REFERENCE TO RELATED APPLICATION

This application claims priority to and the benefit of Korean Patent Application Nos. 10-2013-0151678, 10-2014-0013298, 10-2014-0055861, and 10-2014-0095849 filed in the Korean Intellectual Property Office on Dec. 6, 2013, Feb. 5, 2014, May 9, 2014, and Jul. 28, 2014, the entire contents of which are incorporated herein by reference.

### BACKGROUND OF THE INVENTION

(a) Field of the Invention

The present invention relates to a method and apparatus for cell discovery.

(b) Description of the Related Art

A cell discovery process performed by a terminal includes at least two processes. In detail, the cell discovery process performed by a terminal includes a process of estimating a parameter for checking cell identification information (e.g., a physical layer cell ID, a virtual cell ID, or the like), and a process of estimating (measuring) quality of a radio link between a cell and a terminal.

Meanwhile, a method for cell discovery for a long term evolution (LTE) mobile communication system is required.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and apparatus for cell discovery for a long-term evolution (LTE) mobile communication system.

An exemplary embodiment of the present invention provides a method for cell discovery of a terminal. The method for cell discovery may include measuring quality of a radio link by using at least one first orthogonal frequency division multiplexing (OFDM) symbol among OFDM symbols excluding an OFDM symbol including a channel state information (CSI)-reference signal (RS).

The CSI-RS may be used as a cell discovery signal.

The method may further include reporting the measured quality of the radio link to a serving cell.

The method may further include receiving, from a serving cell, first information including a period of a first subframe for measurement of quality of a radio link, an offset of the first subframe, and an index of the first OFDM symbol in the first subframe.

The measuring may include measuring a received signal strength indicator (RSSI) in the first subframe based on the first information.

A physical downlink shared channel (PDSCH) or a demodulation (DM)-RS may be configured in the first OFDM symbol.

Another embodiment of the present invention provides a method for cell discovery of a terminal. The method may include: receiving configuration information of a CSI-RS from a serving cell through radio resource control (RRC) signaling; determining a plurality of first subframes that are consecutive based on the CSI-RS configuration information; receiving the CSI-RS from a plurality of cells adjacent to the terminal by using the plurality of first subframes; and measuring quality of a radio link by using the CSI-RS.

The CSI-RS configuration information may include a period of the first subframes, an offset of the first subframes, and the number of consecutive first subframes.

The CSI-RS may include at least one among zero power (ZP) CSI-RS and non-ZP (NZP) CSI-RS.

The CSI-RS configuration information may further include the number of first antenna ports for transmitting and receiving the ZP CSI-RS.

The CSI-RS configuration information may further include a position of a first resource for transmitting and receiving the ZP CSI-RS in the first subframe.

The receiving of a CSI-RS may include: determining the position of the first resource in the first subframe based on the CSI-RS configuration information.

The number of resource elements that the first resource occupies in the first subframe may be two when the number of first antenna ports for the first subframe is one or two. The CSI-RS configuration information may further include the number of first resources for transmitting and receiving the NZP CSI-RS.

The receiving of a CSI-RS may include: determining the number of first resources in the first subframe based on the CSI-RS configuration information.

A period of the first subframe and a period of a second subframe in which the CSI-RS is transmitted and received may be different.

The measuring of quality of a radio link may include: measuring radio resource measurement (RRM) by using the first resource; and measuring a CSI by using the first resource.

The measuring of quality of a radio link may include: measuring RRM by using the first resource; and measuring a CSI by using a second resource different from the first resource.

The second resource may be a resource for transmitting and receiving the NZP CSI-RS.

The CSI-RS configuration information may further include the number of first antenna ports for transmitting and receiving the NZP CSI-RS.

When the number of the first antenna ports is plural, the plurality of first antenna ports may use the same OFDM symbol and different subcarriers in the first subframe.

The measuring of quality of a radio link may include measuring RRM by using a weight value used for code division multiplexing (CDM).

The weight value for two resource elements (REs) may be either [1, 0] or [0, 1].

A period of the first subframe may be one among 160 ms, 320 ms, 640 ms, and 1280 ms.

The measuring of quality of a radio link may include measuring an RSSI by using a plurality of first resources of the first subframe.

The plurality of first resources may include all the resources for receiving the CSI-RSs from the plurality of adjacent cells.

The measuring of quality of a radio link may include, when the first resource and a second resource for transmitting and receiving the NZP CRI-RS exist in the same first subframe, measuring RRM and CSI by using both the first resource and the second resource.

Yet another embodiment of the present invention provides a method for cell discovery of a serving cell. The method for cell discovery of a serving cell may include: including the number of first antenna ports for transmitting and receiving a zero power (ZP) channel state information (CSI)-reference signal (RS) in configuration information of a CSI-RS used as a cell discovery signal; when the number of the first antenna ports is two or less, including a position of a first resource for transmitting and receiving the ZP CSI-RS in the CSI-RS configuration information; transmitting the CSI-RS configuration to a terminal through radio resource control (RRC) signaling; and receiving quality of a radio link measured by the terminal from the terminal.

Still another embodiment of the present invention provides a method of measuring radio resource measurement (RRM) by a terminal. The method of measuring RRM by a terminal may include: measuring reference signal received power (RSRP) by using a resource for a channel state information (CSI)-reference signal (RS); and reporting the measured RSRP to a serving cell.

The method may further include: measuring a received signal strength indicator (RSSI) by using an orthogonal frequency division multiplexing (OFDM) symbol not including a CSI-RS; measuring reference signal received quality (RSRQ) by using the RSRP and the RSSI; and reporting the measured RSRQ to the serving cell.

### BRIEF DESCRIPTION OF THE DRAWINGS

FIG. 1 is a view illustrating a cell deployment environment.

FIG. 2 is a view illustrating information elements for configuring a channel state information-reference signal (CSI-RS).

FIG. 3 is a view illustrating an example of configuring subframes for burst transmission of a CSI-RS.

FIG. 4 is a view illustrating configuration of subframes for burst transmission of a CSI-RS according to an exemplary embodiment of the present invention.

FIG. 5 is a view illustrating an example of a zero power (ZP) CSI-RS.

FIG. 6 is a view illustrating a CSI-RS subframe or a ZP CSI-RS subframe according to an exemplary embodiment of the present invention.

FIG. 7 is a view illustrating a CSI-RS subframe for which multiple CSI-RS resources are set according to an exemplary embodiment of the present invention.

FIG. 8 is a view illustrating a cell discovery signal when the number of CSI-RS resources is set differently over time according to an exemplary embodiment of the present invention.

FIG. 9 is a view illustrating a CSI-RS subframe configured according to an antenna port aggregation method according to an exemplary embodiment of the present invention.

FIG. 10 is a view illustrating an example of CSI-RS subframes to explain accuracy of RSRQ measurement.

FIGS. 11A, 11B, and 11C are views illustrating CSI-RS subframes for a small cell when a received signal strength indicator (RSSI) is measured in units of resource elements (REs) according to an exemplary embodiment of the present invention.

FIG. 12 is a view illustrating RSSI measurement REs for a terminal when RSSI is measured in units of REs according to an exemplary embodiment of the present invention.

FIGS. 13A, 13B, 13C, and 13D are views illustrating CSI-RS subframes for a small cell in a dormant state and a small cell in an active state when an RSSI is measured in units of REs according to an exemplary embodiment of the present invention.

FIG. 14 is a view illustrating a configuration of a terminal according to an exemplary embodiment of the present invention.

FIG. 15 is a view illustrating a configuration of a macro base station (BS) corresponding to a macro cell according to an exemplary embodiment of the present invention.

FIG. 16 is a view illustrating a configuration of a small BS corresponding to a small cell according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, a terminal may refer to a mobile terminal (MT), a mobile station (MS), an advanced mobile station (AMS), a high reliability mobile station (HR-MS), a subscriber station (SS), a portable subscriber station (PSS), an access terminal (AT), user equipment (UE), or the like, and may include an entirety or a portion of functions of an MT, an MS, an AMS, an HR-MS, an SS, a PSS, an AT, a UE, or the like.

Also, a base station (BS) may refer to an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) serving as a base station, a high reliability relay station (HR-RS) serving as a base station, or the like, and may include the entirety or a portion of functions of an ABS, a node B, an eNodeB, an AP, an RAS, a BTS, an MMR-BS, an RS, an HR-RS, or the like.

### 1. Outline of Cell Discovery

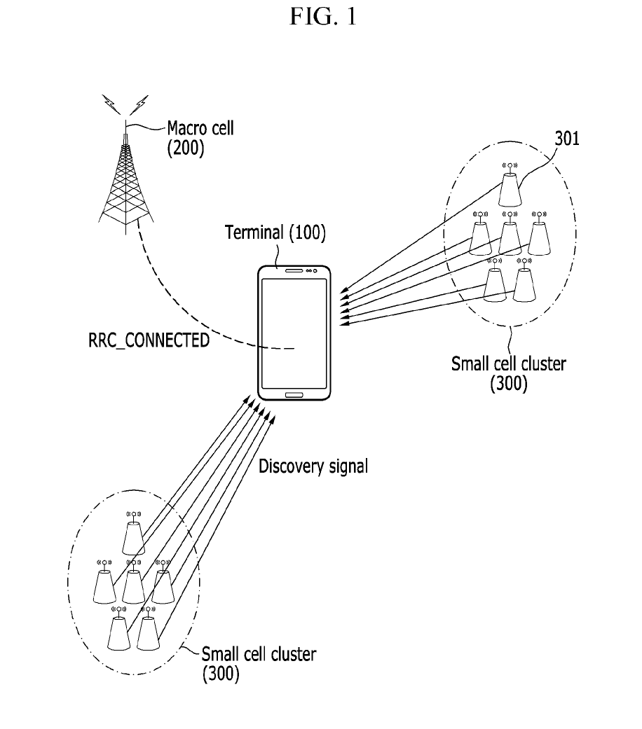

FIG. 1 is a view illustrating a cell deployment environment.

In a wireless network where a large cell or a macro cell 200 is disposed, a small cell cluster 300 is disposed. The small cell cluster 300 includes a plurality of small cells 301. The macro cell 200 corresponds to a macro base station (BS). The small cells 301 correspond to a small BS.

The small cells 301 are connected through a backhaul. The small cells 301 in the small cell cluster 300 may be synchronized in time and frequency through the backhaul or a protocol between small cells. Meanwhile, time and frequency synchronization between the large cell (or the macro cell) 200 and the small cell clusters 300 is not required.

The macro cell 200 and a terminal 100 may be in a radio resource control (RRC)_connected state.

The small cell cluster 300 may transmit a cell discovery signal to the terminal 100.

Hereinafter, for the purposes of description, it is assumed that the macro cell 200 uses a frequency F1 and the small cell cluster 300 uses a frequency F2. Here, the frequency F1 and the frequency F2 may be identical or different.

Meanwhile, the macro cell 200 or a small cell 301 may be in any one of an active state, a dormant (DTx) state, and an inactive state. The macro cell 200 or the small cells 301 may transition in state.

The macro cell 200 or the small cell 301 in the active state may transmit every signal and every channel by utilizing every resource.

The macro cell 200 in a dormant state may transmit a cell discovery signal by using a partial time and a partial frequency resource according to pre-set dormant periods. For example, the macro cell 200 or the small cell 301 in the dormant state may transmit only a synchronization signal (SS) and a cell-specific reference signal (CRS) within a single subframe with a period of 5 ms, and may not transmit any other signals. In another example, the macro cell 200 or the small cell 301 in the dormant state may set SS two times and channel state information-reference signal (CSI-RS) ten times within ten subframes with a period of 200 ms and transmit the same.

The macro cell 200 or the small cell 301 in an inactive state may not transmit any signal.

A state of the small cell 301 may be changed through signaling based on backhaul. Also, a state of the small cell 301 may be changed by the small cell 301 itself.

A state of the macro cell 200 or the small cell 301 may be changed depending on a measurement result of a cell discovery signal by a terminal. Also, in a case in which an excessive traffic load is applied to a small cell 301, a dormant state of the small cell 301 loaded with excessive traffic may be changed to an active state.

Meanwhile, in a case in which a small base station (BS) manages a plurality of small cells 301 operating in a plurality of frequencies, a state of each of the small cells 301 managed by the small BS may be defined.

In an exemplary embodiment of the present invention, a CSI-RS or an improved CSI-RS is used as a cell discovery signal.

### 2. Method of Utilizing CSI-RS as Cell Discovery Signal

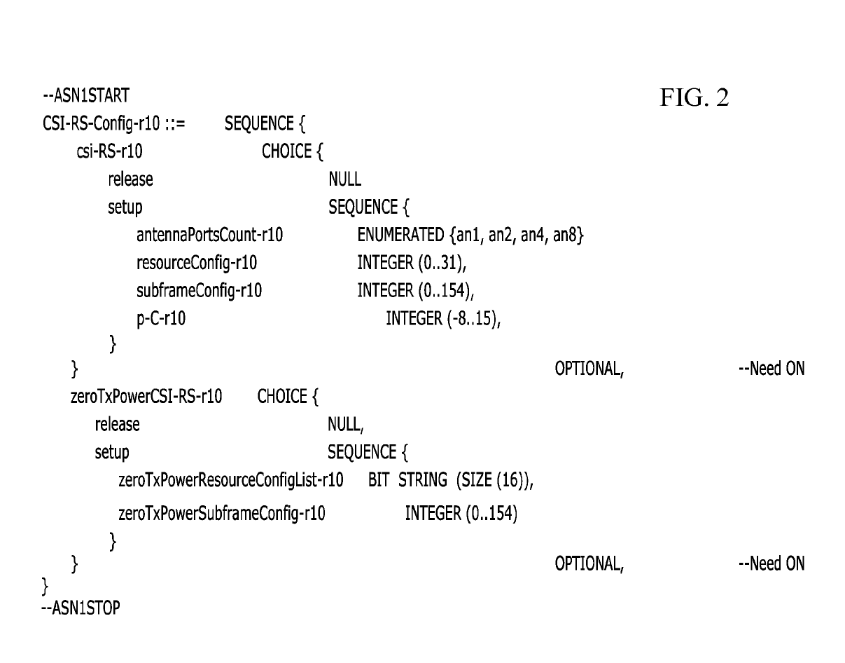

FIG. 2 is a view illustrating an information element for configuring a CSI-RS (hereinafter referred to as a “CSI-RS IE”). In detail, FIG. 2 illustrates a CSI-RS IE defined in 3GPP (3rd Generation Partnership Project) TS (Technical Specification) 36.331.

In CSI-RS IE, csi-RS-r10 includes information for configuring a CSI-RS. In detail, csi-RS-r10 may include antennaPortsCount-r10, resourceConfig-r10, subframeConfig-r10, and p-C-r10

antennaPortsCount-r10 denotes an antenna port to be used by the CSI-RS or an antenna port for transmitting and receiving the CSI-RS. resourceConfig-r10 denotes configuration of resources to be used by the CSI-RS in conformity with 3GPP TS 36.211 or configuration of resources for transmitting and receiving the CSI-RS. subframeConfig-r10 denotes a configuration of a temporal position of a CSI-RS subframe in conformity with 3GPP TS 36.211. Here, the CSI-RS subframe denotes a subframe in which the CSI-RS is transmitted and received. p-C-r10 denotes a power ratio of an RE for physical downlink shared channel (PDSCH) and an RE for the CSI-RS in conformity with the 3GPP TS 36.213.

CSI-RS IE zeroTxPowerCSI-RS-r10 includes information for configuring zero power (ZP) CSI-RS. In detail, zeroTxPowerCSI-RS-r10 may include zeroTxPowerResourceConfigList-r10 and zeroTxPowerSubframeConfig-r10. The zeroTxPowerResourceConfigList-r10 denotes configuration of resources to be used by the ZP CSI-RS or configuration of resources for transmitting and receiving the ZP CSI-RS. zeroTxPowerSubframeConfig-r10 denotes configuration of a temporal position of a ZP CSI-RS subframe in conformity with 3GPP TS 36.211. Here, the ZP CSI-RS subframe denotes a subframe in which the ZP CSI-RS is transmitted and received.

The macro cell 200 transmits a CSI-RS IE including configuration information of the CSI-RS and the ZP CSI-RS to the terminal 100 through RRC signaling. In detail, the macro cell 200 is RRC_CONNECTED with the terminal 100. The terminal 100 configures a CSI-RS and a ZP CSI-RS according to the CSI-RS IE transmitted from the macro cell 200. The terminal 100 measures a CSI-RS RE including the CSI-RS to generate a reference signal received power (RSRP) value or a reference signal received quality (RSRQ) value and reports the generated values to a serving cell. Here, the serving cell may be the macro cell 200 RRC_CONNECTED with the terminal 100.

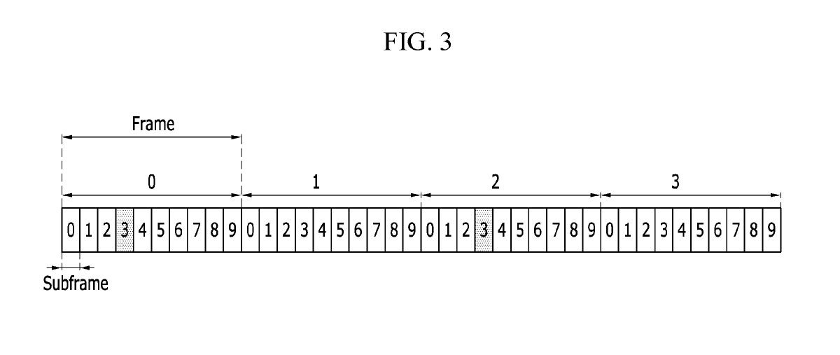

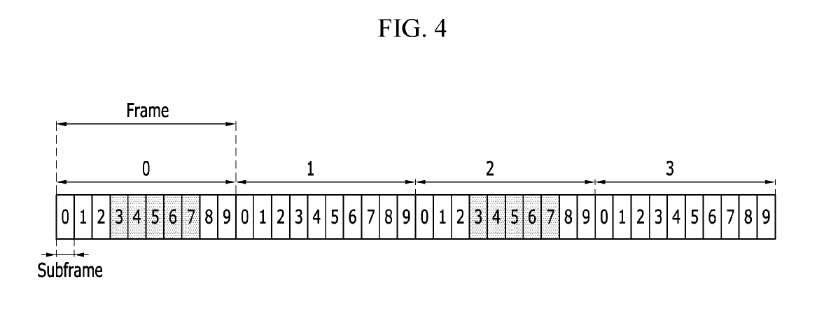

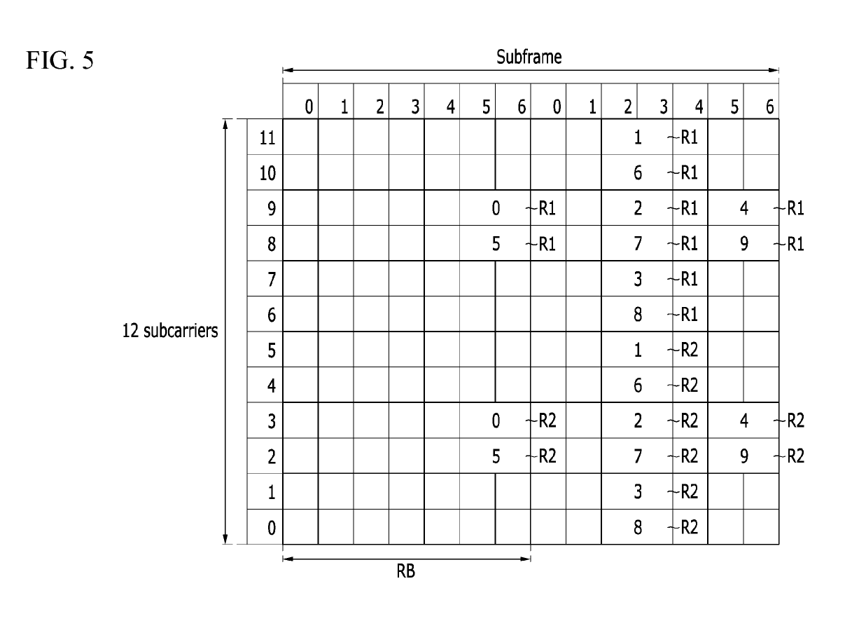

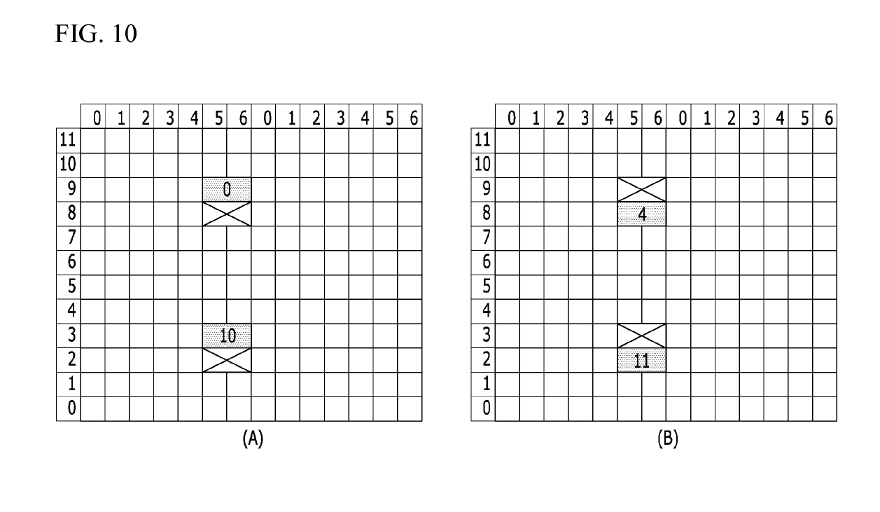

Meanwhile, in a case in which the CSI-RS proposed in the LTE standard is utilized as a cell discovery signal, whether burst transmission is supported, a configuration unit of the ZP CSI-RS, a degree of freedom of configuration of CSI-RS resource, and accuracy in RSRQ measurement using the CSI-RS need to be considered. The case in which burst transmission is supported will be described with reference to FIGS. 3 and 4. A configuration unit of the ZP CSI-RS and a degree of freedom in configuration of CSI-RS resource will be described with reference to FIGS. 5 through 9. Accuracy of RSRQ measurement will be described with reference to FIGS. 10 through 12 and FIGS. 13A through 13D.

### 3. Burst Transmission

FIG. 3 is a view illustrating an example of configuring subframes for burst transmission of a CSI-RS.

In a case in which a CSI-RS is used to search for the small cells 301 that are densely disposed, the terminal 100 needs to receive all of CSI-RSs transmitted from the small cells 301. If the small cells 301 transmits CSI-RS by using different periods and different subframe offsets for the purpose of controlling inter-cell interference, the terminal 100 should observe a large number of subframes. When the terminal 100 is in a dormant DRx state, if a dormant period of the terminal 100 and periods and offsets of the CSI-RS subframes are not identical, a large amount of time is required for the terminal 100 in the dormant state to detect a corresponding small cell 301. Also, when measuring other frequencies through burst transmission, the terminal 100 may be able to measure a large number of component carriers (CCs) in a single measurement gap.

That is, as the number of subframes observed by the terminal 100 is greater, a time for the terminal 100 to search for cells is lengthened and power consumption of the terminal 100 increases.

Thus, by configuring such that a plurality of small cells 301 transmit CSI-RSs in the same subframe through burst transmission, the terminal 100 may detect a larger number of small cells 301 in a short time. Also, in order to save power of the small cells 301, preferably, the small cells 301 secure a large number of subframes in which a CSI-RS is not transmitted.

Meanwhile, configuration information of a CSI-RS subframe includes a period and an offset of a CSI-RS subframe. By configuring such that the densely disposed small cells 301 have a similar CSI-RS subframe period and a similar CSI-RS subframe offset, preferably, the terminal 100 receives CSI-RSs of all the small cells 301 even though the terminal observes a small number of CSI-RS subframes.

In order to save power of the small cells 301 and the terminal 100, preferably, a period of a CSI-RS subframe is configured to be sufficiently long. In order to cope with changing quality of a wireless channel over time, and in order to measure RSRP and RSRQ more accurately, the small cells 301 may periodically transmit CSI-RS subframes.

Since only a period and an offset of a CSI-RS subframe can be configured, in order to implement burst transmission in time resource, a CSI-RS subframe needs to be configured periodically, and after a required time has lapsed, the set CSI-RS subframe needs to be released. To this end, the serving cell (e.g., 200) should periodically perform RRC signaling to the terminal 100.

Thus, a new configuration of a CSI-RS subframe is required to support burst transmission through single RRC signaling.

In order to configure burst transmission using a single CSI-RS IE, preferably, a CSI-RS IE is corrected such that consecutive subframes are configured as CSI-RS subframes. In a case in which consecutive subframes are configured as CSI-RS subframes, the terminal 100 may consecutively measure the CSI-RS subframes, thereby enhancing accuracy of RSRP and RSQ measurement.

In a case in which a period of a CSI-RS subframe is 20 ms and an offset of the CSI-RS subframe is set to 3 (subframe #3) as illustrated in FIG. 3, the terminal 100 should measure RSRP and RSRQ by using only a single subframe (e.g., subframe #3 of frame #0 and subframe #3 of frame #2). In FIG. 3, one frame includes ten subframes.

FIG. 4 is a view illustrating configuration of subframes for burst transmission of a CSI-RS according to an exemplary embodiment of the present invention.

Consecutive subframes may be configured as CSI-RS subframes. In detail, when it is configured such that a period of a CSI-RS subframe is 20 ms, an offset of the CSI-RS subframe is 3, and the number of consecutive CSI-RS subframes is 5, the terminal 100 may use five consecutive subframes (e.g., subframes #3 to #7 of frame #0 and subframes #3 to #7 of frame #2) as CSI-RS subframes. A certain small cell 301 belonging to the small cell cluster 300 burst-transmits a CSI-RS in the configured subframe (e.g., subframes #3 to #7 of frame #0 and subframes #3 to #7 of frame #2), and the terminal 100 receives the CSI-RS in the configured subframe (e.g., subframes #3 to #7 of frame #0 and subframes #3 to #7 of frame #2).

Meanwhile, a CSI-RS has a lower priority than that of a physical broadcast channel (PBCH), a physical multicast channel (PMCH), or a primary synchronization signal (PSS)/secondary synchronization signal (SSS), so the CSI-RS may not be transmitted in a CSI-RS subframe according to circumstances (drop).

Meanwhile, in order to reduce inter-cell interference with respect to a CSI-RS, the same configuration scheme as that of the CSI-RS is used for a ZP CSI-RS, and thus, preferably, burst transmission is allowed for the ZP CSI-RS.

In detail, csi-RS-r10 and zeroTxPowerCSI-RS-r10 may include a variable of Table 1 below. consecutiveSubframes-r12 may be defined as needed.

TABLE 1

| Variable | type |
|---|---|
| consecutiveSubframes-r12 | INTEGER |

### 4. Configuration of CSI-RS RE

4-1. Configuration range of ZP CSI-RS

FIG. 5 is a view illustrating an example of a zero power (ZP) CSI-RS.

In a case in which the small cells 301 are densely deployed to form a group, the plurality of small cells 301 may transmit CSI-RS at the same time and in the same frequency. In this case, inter-cell interference is so great that a signal-to-interference-plus-noise ratio (SINR) of a CSI-RS experienced by the terminal 100 is reduced. In order to reduce this, a ZP CSI-RS may be configured. Power is not included in an RE with the ZP CSI-RS configured therein (hereinafter referred to as “ZP CSI-RS RE). PDSCH rate matching is performed on the ZP CSI-RS RE without power. Due to PDSCH rate matching, the ZP CSI-RS RE may not be used during a channel coding process, a resource mapping process, and the like. Accordingly, even though the terminal 100 receives a PDSCH only in an RE, not in the ZP CSI-RS RE, the terminal 100 may successfully decode a corresponding transport block (TB).

In a case in which the ZP CSI-RS is configured, an RE for a PDSCH (hereinafter referred to as “PDSCH RE”), a resource allocated by the small cell 301, does not interfere with a CSI-RS RE allocated by another small cell 301, so an SINR of the CSI-RS increases.

Configuration of the ZP CSI-RS follows Table 6.10.5.2-1 of 3GPP TS 36.211. In detail, a configuration of the ZP CSI-RS follows the configuration of the CSI-RS in the case in which four antenna ports (e.g., #15 to #18) are used. FIG. 5 illustrates a resource grid of an antenna port-based ZP CSI-RS subframe. One subframe includes a resource block (RB) pair. One RB includes seven orthogonal frequency division multiplexing (OFDM) symbols in a time axis and twelve subcarriers in a frequency axis. In one subframe, resources that may be configured as a ZP CSI-RS RE are R1 and R2. R1 and R2 have the same ZP CSI-RS resource index. For example, in a case in which resource #0 is configured as a ZP CSI-RS RE, R1 of #0 and R2 of #0 may be configured as ZP CSI-RS REs.

A position of an activated ZP CSI-RS RE is determined by zeroTxPowerResourceConfigList-r10. Since the ZP CSI-RS RE may be configured in units of four, if the terminal 100 does not use four antenna ports, it is inefficient. In a case in which the terminal 100 uses one or two antenna ports, when the ZP CSI-RS is configured, the serving cell (e.g., 200) should mute an unnecessary RE. As a result, since the serving cell (e.g., 200) uses a smaller TB, an amount of transmission is reduced.

Meanwhile, in a case in which the terminal 100 uses eight antenna ports, the serving cell (e.g., 200) should transmit CSI-RS IE twice in order to configure two ZP CSI-RS REs. Thus, the serving cell (e.g., 200) should transmit more RRC signaling messages to the terminal 100 by using an additional PDSCH RE. Thus, preferably, configuration granularity of the ZP CSI-RS is to be more diversified.

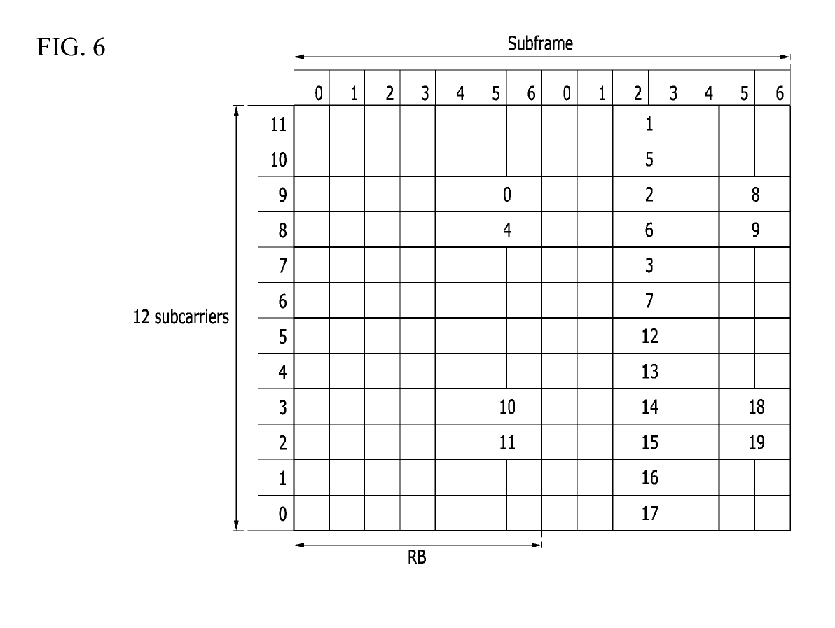

FIG. 6 is a view illustrating a CSI-RS subframe or a ZP CSI-RS subframe according to an exemplary embodiment of the present invention.

The current standard defines that only a CRS should be utilized for RSRP measurement. A CRS uses four REs in the time axis and four REs in the frequency axis in an RB pair. If a CSI-RS is utilized for RSRP measurement, the CSI-RS may need to use a similar number of REs to that of the REs used by a CRS to obtain similar accuracy. Thus, in the case in which a CSI-RS is utilized for RSRP measurement, preferably, a CSI-RS is configured to use at least two REs in the frequency axis in each RB pair. Meanwhile, in many cases, the number of REs occupied in the time axis rarely affects RSRP measurement accuracy and an estimated RSRP value. A UE that moves at a low speed corresponds to this case.

In this case, one or two antenna ports are sufficient for the CSI-RS (antenna ports for transmitting and receiving the CSI-RS), and thus, configuration of a ZP CSI-RS for one or two antenna ports may need to be considered. However, the standard defines only the case in which the ZP CSI-RS uses four antenna ports. Thus, in the case of utilizing a ZP CSI-RS to reduce inter-cell interference from a CSI-RS using one antenna port, unnecessary RE muting should be performed.

Therefore, preferably, ZP CSI-RS configuration information for supporting one or two antenna ports is added to a CSI-RS IE. In the Table 6.10.5.2-1 of 3GPP TS 36.211, configuration of 32 resources that may be configured when a CSI-RS uses one or two antenna ports is defined.

For example, a CSI-RS IE (e.g., zeroTxPowerCSI-RS-r10) for configuring a ZP CSI-RS may include variables as shown in Table 2

TABLE 2

| Variable | type |
|---|---|
| antennaPortsCount-r12 | ENUMERATED {an1-2, an4} |
| zeroTxPowerResourceConfigList-r12 | BIT STRING (SIZE 32) |

antennaPortsCount-r12 defines the number of antenna ports used by a ZP CSI-RS (antenna ports for transmitting and receiving a ZP CSI-RS). In a case in which the number of antenna ports used by the ZP CSI-RS is one or two, a position of the ZP CSI-RS RE may be configured through zeroTxPowerResourceConfigList-r12. Like the case of configuring the ZP CSI-RS RE when the ZP CSI-RS uses four antenna ports, even when the ZP CSI-RS uses one or two antenna ports, a bitmap scheme may be used to configure the ZP CSI-RS RE. FIG. 6 illustrates a ZP CSI-RS subframe that may be configured when the ZP CSI-RS uses one or two antenna ports. In detail, FIG. 6 illustrates a ZP CSI-RS RE that may be configured when the ZP CSI-RS uses two antenna ports. Unlike the case of FIG. 5, in FIG. 6, the number (#0 to #19) of the resources that may be configured as a ZP CSI-RS RE are not repeated.

### 4-2. Configuration of CSI-RS

In a case in which a CSI-RS is used as a cell discovery signal, measurement performance of radio resource measurement should be sufficiently secured under the assumption that accurate synchronization is secured. In the 3GPP TS 36.133 standard, measurement accuracy in case of using a CRS is defined. In particular, when an adjacent cell 301 or a serving cell (e.g., 200) configures an almost blank subframe (ABS) pattern to avoid interference in a time domain, the terminal 100 receives a measurement subframe from the serving cell 300 through RRC signaling and performs RRM measurement only in the corresponding measurement subframe. In this case, in order to follow the 3GPP TS 36.133 standard, the terminal 100 should use four CRS REs (REs for CRS) used by at least antenna port #0 for RRM measurement. Thus, in order to obtain a measurement value similar to accuracy of CRS-based RRM measurement, two or more REs should also be used for RRM measurement in the CSI-RS subframe.

Therefore, in order to configure a CSI-RS subframe, the following two methods (CSI-RS resource multi-configuration method and antenna port aggregation method) may be used. In order to allow a CSI-RS to be utilized as a small cell discovery signal, the following two methods (CSI-RS resource multi-configuration method and antenna port aggregation method) may be combined.

### 4-2-1. CSI-RS Resource Multi-Configuration Method

In the CSI-RS resource multi-configuration method, a plurality of CSI-RS resources, as well as a single CSI-RS resource, are configured in a single CSI-RS subframe. According to 3GPP TS 36.213, up to three different CSI-RS resources may be configured as CSI-RS IEs for CSI-RS configuration. Here, the serving cell (e.g., 200) should transmit three CSI-RS IEs to the terminal 100 through RRC signaling. However, in a case in which three CSI-RSs for which periods and offsets of CSI-RS subframes are identical and only a resource configuration is different are configured, RRC signaling is ineffectively performed three times. In a case in which two CSI-RSs are configured, RRC signaling is ineffectively performed twice for the same reasons. Thus, preferably, a required number of CSI-RS resources are configured through single RRC signaling.

Here, in a case in which a small cell 301 in an active state uses a CSI-RS as a cell discovery signal, a PDSCH transmitted by the small cell 301 in the active state may interfere with a non-ZP (NZP) CSI-RS (i.e., CSI-RS) transmitted by an adjacent small cell 301. In order to reduce interference of the inter-cell PDSCH and NZP CSI-RS, the small cell 301 in the active state may receive a position of an RE to be used by the adjacent small cell 301 from the adjacent small cell 301 or the macro cell 200 through a backhaul. The small cell 301 in the active state may configure a ZP CSI-RS in the position of the RE to be used by the adjacent small cell 301, and apply PDSCH rate matching to the RE with the configured ZP CSI-RS. In a case in which the adjacent small cell 301 uses four antenna ports for a NZP CSI-RS, the small cell 301 in the active state can accurately mute a PDSCH RE with a ZP CSI-RS. In a case in which the adjacent small cell 301 uses one or two antenna ports for a NZP CSI-RS and the small cell 301 in the active state uses a ZP-CSI-RS, the small cell 301 in the active state should mute a larger amount of PDSCH REs than necessary. Thus, a transmission amount of PDSCHs of the small cell 301 in the active state is ineffectively reduced.

Meanwhile, in a case in which the cells 200 and 301 in a dormant DTx state uses a CSI-RS as a cell discovery signal, since a PDSCH is not transmitted, a ZP CSI-RS may not be configured even though a plurality of NZP CSI-RS resources are configured. For example, in a case in which a plurality of CSI-RS resources are configured through a single CSI-RS IE (or single RRC signaling), a CSI-RS IE for configuring a CSI-RS may include a variable as shown in Table 3 below.

TABLE 3

| Variable | type |
|---|---|
| numberResourceConfig-r12 | ENUMERATED {1,2, . . . , |
| | maxNumberResourceConfig} |

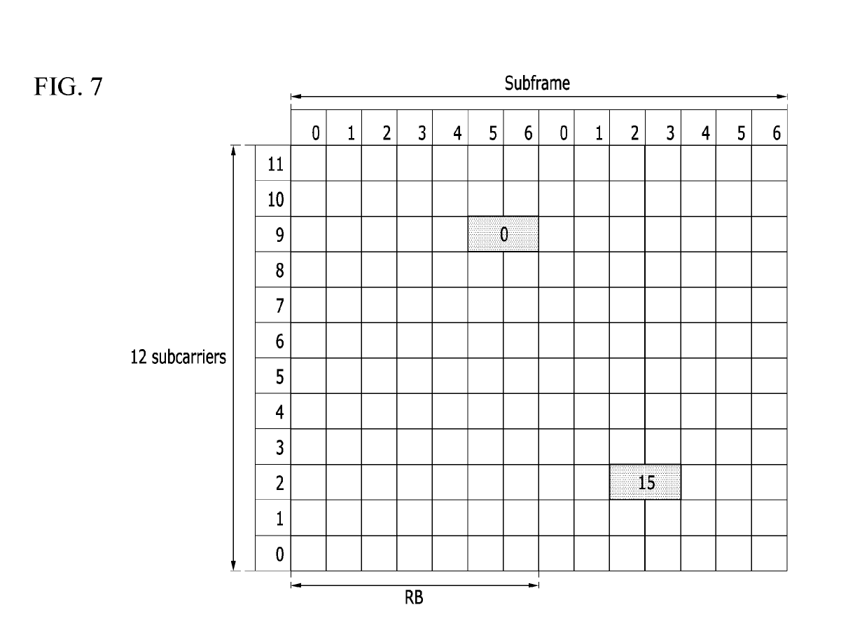

Here, maxNumberResourceConfig denotes a maximum number of CSI-RS resources that may be configured simultaneously in a single CSI-RS subframe. If necessary, numberResourceConfig-r12 may be declared, and a declared number of resourceConfig-r10 may be defined. A case in which a plurality of CSI-RS resources are configured in a single subframe will be described in detail with reference to FIG. 7.

FIG. 7 is a view illustrating a CSI-RS subframe for which multiple CSI-RS resources are set according to an exemplary embodiment of the present invention.

In detail, FIG. 7 illustrates a case in which one antenna port (#15) is used for a CSI-RS and CSR-RS resources of two numbers (#0 and #15) (namely, four CSI-RS REs) are configured in a single subframe. Each of the CSI-RS resources (resource #0 or resource #15) using one antenna port (#15) may correspond to a single physical resource block (PRB). In order to secure RRM measurement accuracy, preferably, subcarriers (e.g., subcarrier #9 and subcarrier #2) respectively used by the CSI-RS resources (resource #0 and resource #15) are spaced apart from one another as far as possible. In FIG. 7, the number of REs used by the CSI-RS is 4 in the time axis and 2 in the frequency axis. Thus, since the number of REs used by the antenna port (e.g., port #0) for the CRS is 4 in the time axis and 4 in the frequency axis, when the terminal 100 moves at a low speed, CSI-RS-based RRM measurement accuracy may be similar to CRS-based RRM measurement accuracy.

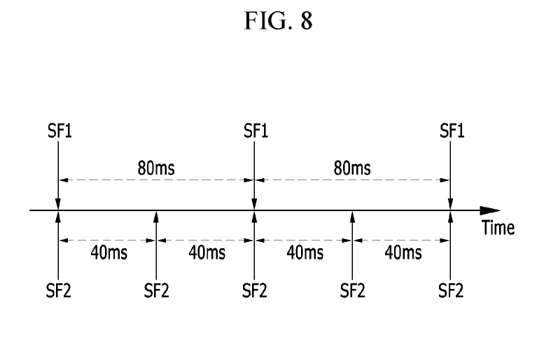

Meanwhile, a CSI-RS resource may be configured differently over time. This will be described in detail with reference to FIG. 8.

FIG. 8 is a view illustrating a cell discovery signal when the number of CSI-RS resources are set differently over time according to an exemplary embodiment of the present invention. Here, one CSI-RS resource configuration is a configuration for two CSI-RS REs.

A plurality of CSI-RS resources may be configured for the small cell 301 in a dormant DTx state, and a plurality of antenna ports for CSI-RS may be configured to the small cell 301 in the active state. In order to further reduce power consumption of the small cell 301, the small cell 301 in the dormant DTx state using a plurality of CSI-RS resources may vary the number of CSI-RS resources over time. For example, the small cell 30 may alternately configure a subframe using two CSI-RS resources (i.e., four CSI-RS REs) and a subframe using one CSI-RS resource (i.e., two CSI-RS REs). In the subframe using two CSI-RS resources (=four CSI-RS REs), the small cell 301 in the dormant DTx state may consume a slightly larger amount of transmission power, and the terminal 100 may consume a slightly larger amount of power because it should execute discrete Fourier transform (DFT) on OFDM symbols a plurality of times (three or more times) in order to decode the corresponding subframes. Meanwhile, in a subframe using one CSI-RS resource (=two CSI-RS REs), the small cell 301 in the dormant DTx state may consume a slightly smaller amount of transmission power, and since the terminal 100 executes DFT on OFDM symbols twice, consuming a slightly smaller amount of power.

In order to vary CSI-RS resource configuration patterns, as illustrated in FIG. 8, the small cell 301 may set a period of a CSI-RS subframe SF1 using one CSI-RS resource (=two CSI-RS REs) as T (e.g., 80 ms) and a period of a CSI-RS subframe SF2 using one CSI-RS resource (=two CSI-RS REs) as T/2 (e.g., 40 ms).

As illustrated in FIG. 8, when the periods of the CSI-RS subframes SF1 and SF2 are set to T and T/2, respectively, the CSI-RS subframe SF1 and the CSI-RS subframe SF2 appear together every 40 ms (i.e., SF1+SF2->SF2->SF1+SF2). In the case in which the CSI-RS subframe SF1 and the CSI-RS subframe SF2 appear together (namely, in the subframe in which two CSI-RS resources (=four CSI-RS REs)), time or frequency synchronization may be obtained. Based on the obtained synchronization, the terminal 100 may perform RRM measurement in the subframe (SF2) in which one CSI-RS resource (=two CSI-RS REs) is configured or in the subframes (SF1+SF2) in which two CSI-RS resources (=four CSI-RS RE) are configured.

Meanwhile, carrier aggregation (CA)-based cell ON/OFF (change in cell state) and dual connectivity (DC)-based cell ON/OFF (change in cell state) need to be considered. The CA-based cell ON/OFF and the DC-based cell ON/OFF may be more quickly performed by using an L1 signal (physical layer signal). Here, the L1 signal, as a cell discovery signal (DRS), refers to a CSI-RS.

The terminal 100 may perform RRM measurement by using a CSI-RS regardless of a state of a serving cell. Here, the serving cell may be the macro cell 200 or the small cell 301 in a case in which CA or DC is considered. In detail, when CA or DC is considered, the macro cell 200 or the small cell 301 may become a serving cell according to an LTE procedure. Namely, the terminal 100 may measure RSRP by using a CSI-RS and measure RSRP by using a CSI-RS. Also, the terminal 100 may perform CSI measurement (e.g., channel quality indication (COI), precoding matrix indication (PMI), rank indication (RI), or the like). The terminal 100 may report or feed back the measurement result to the serving cell (e.g., 200 or 301). Here, the serving cell (e.g., 200 or 301) measured by the terminal 100 is a secondary cell (SCell) in the CA-based cell ON/OFF and a secondary eNB or a primary SCell (pSCell) or a secondary SCell (sSCell) of a secondary cell group (SCG) in the DC-based cell ON/OFF.

Requirements of the CSI-RS based RRM measurement and CSI measurement may be considerably different. For example, in case of a report period, a report period of RRM measurement may range from tens of milliseconds to hundreds of milliseconds, while a report period of CSI measurement may range from a few milliseconds to tens of milliseconds. Also, in case of a CSI-RS sequence length, a CSI-RS sequence for RRM measurement may require a length of an already set measurement bandwidth. However, full band measurement may be assumed for CSI measurement, and thus a CSI-RS sequence for CSI measurement may require a length of a maximum downlink bandwidth. Thus, for RRM measurement and CSI measurement, the following two methods may be considered.

A first method is a method in which the small cell 301 configures a single CSI-RS resource (=two CSI-RS REs) and uses the configured CSI-RS resource for both the CSI-RS-based RRM measurement and the CSI measurement. In the first method, a CSI-RS sequence may have a length of a longer bandwidth among an already set RRM measurement bandwidth and CSI measurement bandwidth. In the first method, a transmission period (ms) of the CSI-RS may be set to the greatest common denominator (GCD) of the CSI-RS-based RRM measurement period and the CSI measurement period. In the first method, the serving cell (e.g., 200 or 301) may perform CSI-RS configuration on the terminal 100 once, and may separately perform RRM measurement configuration and the CSI measurement configuration. However, in case of a narrowband system (e.g., 1.4 MHz to 3 MHz), even though a CSI-RS sequence is transmitted over the full band, the serving cell (e.g., 200 or 301) may not obtain sufficient RRM measurement accuracy. In the case of the narrowband system, a second method may be considered.

The second method is a method in which the small cell 301 configures a CSI-RS resource for a CSI-RS-based RRM measurement and configures a CSI-RS resource for a CSI measurement separately from the resource for the RRM measurement. For example, for CSI-RS-based RRM measurement, the small cell 301 may configure a CSI-RS resource using a single antenna port and set a measurement bandwidth occupied by the CSI-RS to 6 RB and a transmission period to 80 ms. Further, for CSI measurement, the small cell 301 may configure a CSI-RS resource using a single antenna port. In detail, the small cell 301 may configure a different resource from the CSI-RS resource used for the CSI-RS-based RRM measurement, as a CSI-RS resource for CSI measurement. For CSI measurement, the small cell 301 may set a measurement bandwidth occupied by the CSI-RS as a full downlink bandwidth and a transmission period to 20 ms. For the CSI-RS configured for the CSI-RS-based RRM measurement and the CSI-RS configured for CSI measurement, the small cell 301 may configure offsets of the CSI-RS subframes to be the same. This may be virtually to the same as the case in which the serving cell (e.g., 200 or 301) configures two CSI-RS resources (=four CSI-RS REs) for CSI-RS-based RRM measurement. Since the terminal 100 transmits two CSI-RS resources (=four CSI-RS REs) every 80 ms, the terminal 100 may obtain more accurate RRM measurement. Also, the terminal 100 may more accurately obtain time and frequency synchronization in the subframe in which two CSI-RS resources (=four CSI-RS REs) are set. The second method is a method in which two CSI-RS resources are configured. However, since a bandwidth occupied by the CSI-RS resources transmitted for RRM measurement is not wide and a period is long in many cases, although the second method is used, additionally generated inter-cell interference is not significant and the number of REs not used for PDSCH transmission is not considerably increased. Meanwhile, in a case in which two or more CSI-RS resources (=four or more CSI-RS REs) exist (or occur) in the same CSI-RS subframe, the terminal 100 may perform RRM measurement and CSI measurement by using all of the two or more CSI-RS resources existing in the same CSI-RS subframe.

### 4-2-2. Antenna Port Appreciation Method

An antenna port aggregation method may have the same effect to that of a case in which a plurality of CSI-RS antenna ports and a plurality of CSI-RS resources are configured. According to the current standard 3GPP TS 36.213, the cell 200 or 301 may select one (port #15), two (ports #15 and #16), four (ports #15 to #18), or eight (ports #15 to #22) as the number of CSI-RS ports, and the current standard does not support a combination of different antenna ports (e.g., ports #15 and #17). In order to allow RRM measurement accuracy based on a cell discovery signal to satisfy the current standard 3GPP TS 36.133, a plurality of REs are required. Thus, preferably, the cell 200 or 301 uses a plurality of antenna ports for CSI-RS and uses a combination of various antenna ports.

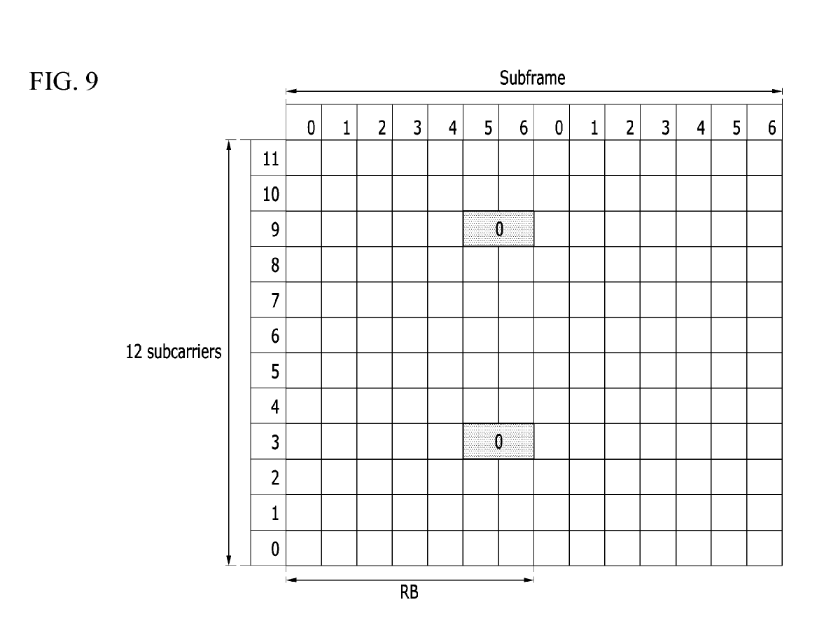

In the antenna port aggregation method, a cell 200 or 301 in a dormant DTx state uses two OFDM symbols. In the foregoing CSI-RS resource multi-configuration method, two or four OFDM symbols are used. Thus, in the antenna port aggregation method, since the number of OFDMs DFT-processed by the terminal 100 is relatively small, an amount of power of a battery consumed by the terminal 100 is also relatively small. The antenna port aggregation method will be described in detail with reference to FIG. 9.

FIG. 9 is a view illustrating a CSI-RS subframe configured according to an antenna port aggregation method according to an exemplary embodiment of the present invention.

As illustrated in FIG. 9, the cell 200 or 301 may use two antenna ports {15, 17} for CSI-RS. A CSI-RS resource configuration number (e.g., resource #0) used by the antenna port #15 and a CSI-RS resource configuration number (e.g., resource #0) used by the antenna port #17 may be identical. In configuring CSI-RS, the number (e.g., 2) of CSI-RS antenna ports and a CSI-RS resource configuration ID (e.g., resource #0) may be set. The antenna ports {15, 17} use the same OFDM symbols (e.g., OFDM symbols #5 and #6) in the time domain and different subcarriers (e.g., subcarrier #9 and subcarrier #3) in the frequency domain. In the antenna port aggregation method, a resource number defined in the current standard, namely, a resource number that may be set in a case in which four CSI-RS antenna ports are used, may be used as a CSI-RS resource number. In the antenna port aggregation method, a code division multiplexing (CDM) weight value defined in the current standard, namely, a CDMD weight value that may be set in a case in which four CSI-RS ports are used, may be used.

Meanwhile, in the antenna port aggregation method, in case of using only two of antenna ports for CSI-RS {15, 16, 17, 18}, any one of antenna ports for CSI-RS {15, 17}, {16, 18}, {15, 16}, {15, 18}, {16, 17}, and {15, 18} may be selected. REs used by an antenna port combination {15, 16} are identical, and REs used by an antenna port combination {17, 18} are identical. Thus, when these combinations are used, the number of REs is not increased, and thus the antenna port aggregation method may not be applied. In a case in which the antenna port aggregation method is applied and the entirety or a portion of the other remaining antenna port combinations (e.g., {15, 18}, {16, 17}, {15, 18}) is configured to be used, a resource number regulation applied to the case in which four CSI-RS antenna ports are configured in the current LTE standard may be re-applied. Here, the resource number denotes a position of a CSI-RS resource. For example, a CSI-RS resource #0 is a resource corresponding to a subcarrier #9 and OFDM symbols #5 and #6 in the left RBs of the subframe of FIG. 9.

### 4-3. Method of Configuring CDM Weight Value Vector

In a case in which a CSI-RS is used for RRM measurement for cell discovery, the number of REs in the time axis does not significantly affect the RRM measurement. Meanwhile, even in a case in which a CSI-RS uses one antenna port, two REs are grouped in the time axis through CDM so as to be used. This is ineffective. Namely, the use of only one RE even in the time axis may be more advantageous in terms of power consumption of the small cell 301 and the terminal 100. Also, even though only one RE is used in the time axis, the low-speed terminal 100 is rarely affected over RSRP or RSRQ measurement accuracy and estimated values.

In a case in which a CSI-RS is used as a cell discovery signal, a weight value used for CDM (CDM weight value) may be set to [1,0] or [0,1]. Namely, in order to allow only one RE to be used for RRM measurement, a CDM weight value for two REs may be set to [1,0] or [0,1]. Among the two REs, an RE in which a CDM weight value is set to 0 may be configured as a PDSCH RE, and rate matching may be performed on the RE configured as the PDSCH RE. In detail, the serving cell (e.g., 200) may set a CDM weight value. A cell (e.g., 200 or 301) that simultaneously transmits a CSI-RS and a PDSCH may perform rate matching.

In detail, a CDM weight value adjusted according to identification information (ID) of the cell (e.g., 200 or 301) may be defined as expressed by Equation 1 below.

$${w}_{t} = \{ \begin{matrix}1 - \{ ( {N}_{ID}^{CSI} + t ) mod 2 \} x , & p ∈ \{ 15 , 17 , 19 , 21 \} , \\ {( - 1 )}^{t} , & p ∈ \{ 16 , 18 , 20 , 22 \}\end{matrix} \qquad ( Equation 1 )$$

where x=0 unless configured by higher layers, (t={0,1})

Here, p denotes an antenna port number. x, unless a value thereof is set by a higher layer, has a value 0. If a CSI-RS is used for the purpose of cell discovery and antenna port #15 is used, x is set to 1. The CDM weight value wₜ has a value of [1, 0] or [0, 1] according to identification information N_{ID}^{CSI} of the cell 200 or 301. In this case, the terminal 100 may perform RRM measurement by using only one RE for every CSI-RS configuration in a corresponding RB.

### 4-4. Method of Extending Period of CSI-RS Subframe

A CSI-RS subframe defined in Table 6.10.5.3-1 of 3GPP TS 36.211 has five periods of 5 ms, 10 ms, 20 ms, 40 ms, and 80 ms. The small cell 301 may transmit one CSI-RS subframe every 80 ms, the longest period. However, in order to save power of the small cell 301, preferably, the period of the CSI-RS subframe is configured to be longer than 80 ms.

In detail, as illustrated in Table 4 below, the CSI-RS subframe may be configured to have various periods and offsets.

TABLE 4

| CSI-RS | Periodicity of CSI-RS | Offset of CSI-RS subframe |
|---|---|---|
| SubframeConfig | subframe | Δ_{CSI-RS} |
| I_{CSI-RS} | T_{CSI-RS} (subframes) | (subframes) |
| 0-4 | 5 | I_{CSI-RS} |
| 5-14 | 10 | I_{CSI-RS} − 5 |
| 15-34 | 20 | I_{CSI-RS} − 15 |
| 35-74 | 40 | I_{CSI-RS} − 35 |
| 75-154 | 80 | I_{CSI-RS} − 75 |
| 155-314 | 160 | I_{CSI-RS} − 155 |
| 315-634 | 320 | I_{CSI-RS} − 315 |
| 635-1274 | 640 | I_{CSI-RS} − 635 |
| 1275-2554 | 1280 | I_{CSI-RS} − 1275 |
| | Reserved | |

In this case, subframeConfig-r10 of a CSI-RS IE may need to be changed to a variable such as that in Table 5.

TABLE 5

| variable | type |
|---|---|
| subframeConfig-r12 | INTEGER (0 . . . 2554) |

### 5. RRM Measuring Method and CSI Measuring Method

The terminal 100 may measure quality of a radio link or a channel.

### 5-1. Measurement Accuracy of CSI-RS-Based RSRQ

RSRQ may be obtained by dividing RSRP and a received signal strength indicator (RSSI) measured in the same subframe to obtain a value and multiplying the number of RBs used for the measurement by the obtained value. The RSRP may be calculated by arithmetically averaging power received by a CSI-RS RE. The RSSI may be calculated by arithmetically averaging power received by OFDM symbols including CSI-RSs. In a case in which a CSI-RS is used for the purpose of cell discovery, a ZP CSI-RS may be used to increase a cell detection probability. In the case in which the ZP CSI-RS is used, OFDM symbols used for calculating the RSSI do not include inter-cell interference (namely, inter-cell interference has been removed). Thus, since the RSSI is calculated in the state in which inter-cell interference has been removed, inaccurate RARQ may be obtained. RSRQ measurement accuracy in the case in which the ZP CSI-RS is configured will be described in detail with reference to FIG. 10.

FIG. 10 is a view illustrating an example of CSI-RS subframes to explain accuracy of RSRQ measurement.

In FIG. 10, (A) illustrates a case in which a first small cell 301 in a dormant DTx state configures CSI-RS resource configuration {0, 10} and ZP CSI-RS resource configuration {5} by using an antenna port {15}. Here, for the ZP CSI-RS, the resource number regulation in the case in which four CSI-RS antenna ports are configured in the current standard may be re-applied. A position of ZP CSI-RS resource #5 may be a position illustrated in FIG. 5. Positions of CSI-RS resources #0 and #10 with respect to the antenna port #15 may be positions illustrated in FIG. 6. In detail, (A) of FIG. 10 illustrates a case in which ZP CSI-RS and PDSCH rate matching are applied and the CSI-RS resources {0, 10} are configured for the antenna port #15. Namely, a resource corresponding to subcarrier #8 with respect to OFDM symbols #5 and #6 in the left RBs of the subframe illustrated in (A) of FIG. 10 is configured as a ZP CSI-RS resource, and a resource corresponding to subcarrier #2 with respect to OFDM symbols #5 and #6 is configured as a ZP CSI-RS resource. (B) of FIG. 10 illustrates a case in which a second small cell 301 in a dormant DTx state configures CSI-RS resource configuration {4, 11} and ZP CSI-RS resource configuration {0} by using antenna port {15}. Namely, a resource corresponding to subcarrier #9 with respect to the OFDM symbols #5 and #6 in the left RBs of the subframe illustrated in (B) of FIG. 10 is configured as a ZP CSI-RS resource, and a resource corresponding to subcarrier #3 with respect to OFDM symbols #5 and #6 is configured as a ZP CSI-RS resource. The first small cell 301 and the second small cell 301 are different.

When the terminal 100 uses the OFDM symbols #5 and #6 to measure RSSI, since the first small cell 301 and the second small cell 301 have avoided inter-cell interference through ZP CSI-RS configuration in advance, there is no inter-cell interference. Thus, an interference component is not calculated when calculating RSSI.

### 5-2. Method of Measuring CSI-RS Based RSRQ

The terminal 100 should measure RSRP and RSSI in order to measure RSRQ. The current standard defines CRS-based RSRQ measurement. However, in a case in which a CSI-RS is used as a cell discovery signal, a method of measuring CSI-RS-based RSRQ is required.

The terminal 100 may measure RSRP according to configuration information of a CSI-RS, like the method defined in 3GPP TS 36.2124.

Meanwhile, in a case in which a ZP CSI-RS is configured or in a case in which the small cell 301 in a dormant DTx state is adjacent to the terminal 100, if the terminal 100 measures RSSI by using a CSI-RS, inaccurate RSSI may be obtained. In order to solve this problem, the following two methods (method of signaling an OFDM symbol index and a method of measuring RSSI in units of REs) may be considered.

After measuring RSSI, the terminal 100 reports RSRQ to the serving cell (e.g., 200). Meanwhile, without reporting the RSSI to the serving cell (e.g., 200), the terminal 100 may internally use the RSSI to calculate RSRQ.

### 5-2-1. Method of Signaling Index of OFDM Symbol to Measure RSSI

At the time when the terminal 100 measures RSSI, if a ZP CSI-RS has not been configured in an OFDM symbol for RSSM measurement, calculation accuracy of RSSI may be increased. If a ZP CSI-RS has been configured in an OFDM symbol for RSSI measurement, the terminal 100 does not receive an interference component in the RE including the configured ZP CSI-RS. Thus, a small amount of interference may be measured in the OFDM symbol in which the ZP CSI-RS has been configured.

Also, in a case in which the small cell 301 in a dormant DTx state transmits only a CSI-RS, if a CSI-RS is configured in an OFDM symbol measured by the terminal 100, the terminal 100 may measure interference to be large.

In order to solve the problem, the terminal 100 may measure RSSI by using an OFDM symbol in which a PDSCH or a demodulation (DM)-RS of the cell 200 or 301 is allocated, in a subframe in which a CSI-RS or a ZP CSI-RS of the cell 200 or 301 has not been configured. If the terminal 100 measures RSSI in the CSI-RS or ZP CSI-RS subframe, the terminal 100 may not use an OFDM symbol in which CSI-RS or ZP CSI-RS has been configured for RSSI measurement. In detail, the serving cell (e.g., 200) may deliver configuration information of a subframe for RSSI measurement to the terminal 100 through RRC signaling. The terminal 100 may measure RSSI by using a configured OFDM symbol in the subframe corresponding to the received configuration information. Here, the OFDM symbol for RSSI measurement may not include a cell discovery signal (e.g., CSI-RS or ZP CSI-RS). Here, measurement of RSSI follows the existing LTE standard.

Meanwhile, an RSSI measurement subframe may be configured by the following two methods (first configuring method and second configuring method).

In case of using the first configuring method, an OFDM symbol for RSSI measurement may be variably configured. Configuration information of the RSSI measurement subframe according to the first configuring method may include a period of a RSSI measurement subframe, an offset of the RSSI measurement subframe, and an index of an OFDM symbol to be used for RSSI measurement (an index of an OFDM symbol in an RSSI measurement subframe).

In case of using the second configuring method, an OFDM symbol for RSSI measurement may be defined in the standard. In the case of using the second configuring method, the OFDM symbol for RSSI measurement may be an OFDM symbol in which a CSI-RS or a ZP CSI-RS is not configured (e.g., an OFDM symbol in which a PDSCH or a DM-RS is configured, or the like). The configuration information of the RSSI measurement subframe according to the second configuring method may include a period of the RSSI measurement subframe and an offset of the RSSI measurement subframe.

### 5-2-2. Method of Measuring RSSI in Units of RE

An RSSI is a value obtained by arithmetically averaging power received in particular OFDM symbols

However, in a situation in which a CSI-RS and a ZP CSI-RS are present together, the terminal 100 may not discover an OFDM symbol in which both a signal of the serving cell (e.g., 200) and an interference signal of an adjacent cell (e.g., 301) are received, all the time.

For example, in the case illustrated in FIG. 10, when the terminal 100 measures an RSSI by using the CSI-RS, an inaccurate RSSI is obtained. Since CSI-RS resource configurations of the first small cell 301 corresponding to (A) of FIG. 10 and the second small cell 301 corresponding to (B) of FIG. 10 are orthogonal, the terminal 100 may not measure a signal and interference in the same RE by using the OFDM symbol #5 and the OFDM symbol #6. For this reason, the terminal obtains an inaccurate RSSI. Also, since the first small cell 301 and the second small cell 301 are in a dormant state, they do not transmit PDSCH. Since a PDSCH is not transmitted, there is no component acting as interference. Nonetheless, since the CSI-RS is transmitted, the RSSI value does not reflect an actual radio channel situation. The reason why the RSSI is inaccurately calculated is because the terminal 100 measures the RSSI in units of OFDM symbols. Thus, in order to solve the problem, the terminal 100 may measure the RSSI by using a subframe in which a CSI-RS is not configured, or may measure the RSSI in units of RE, rather than in units of OFDM symbols.

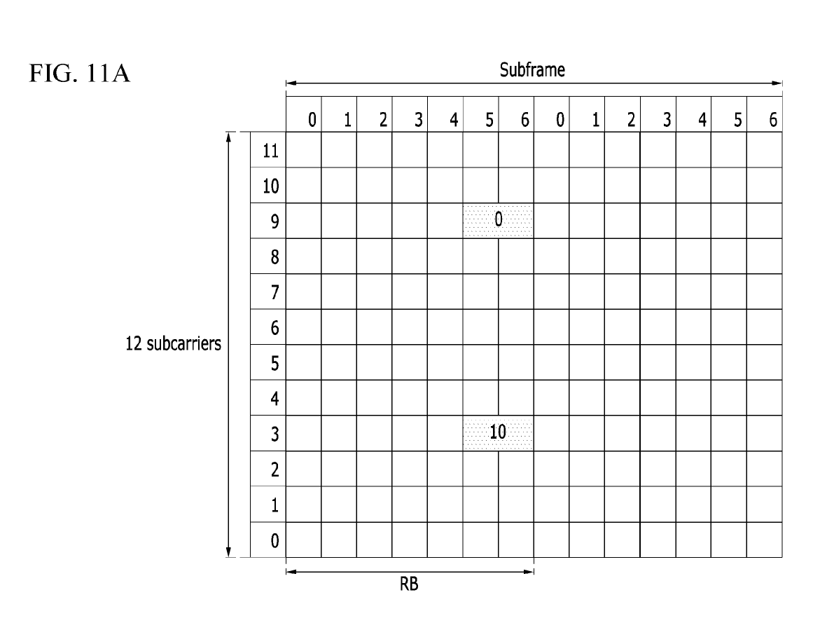

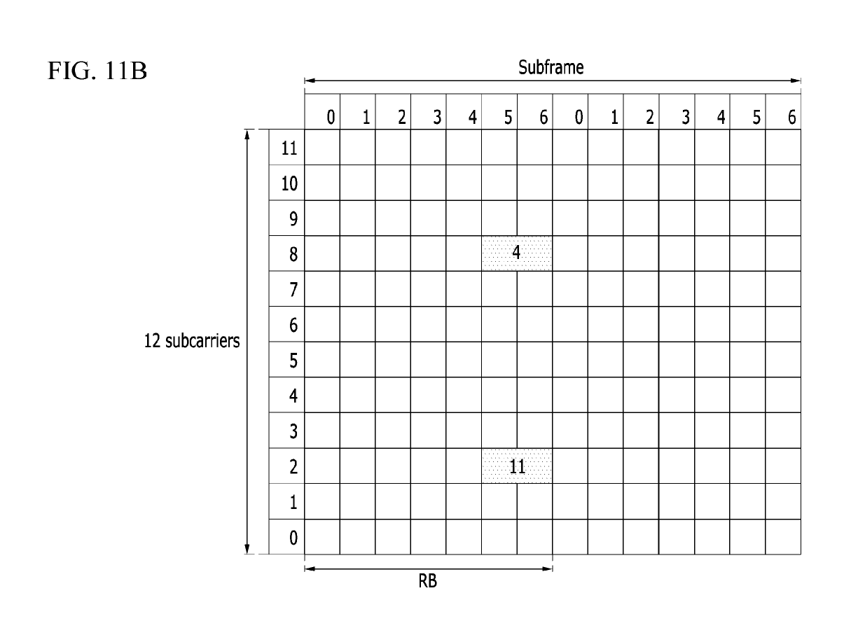

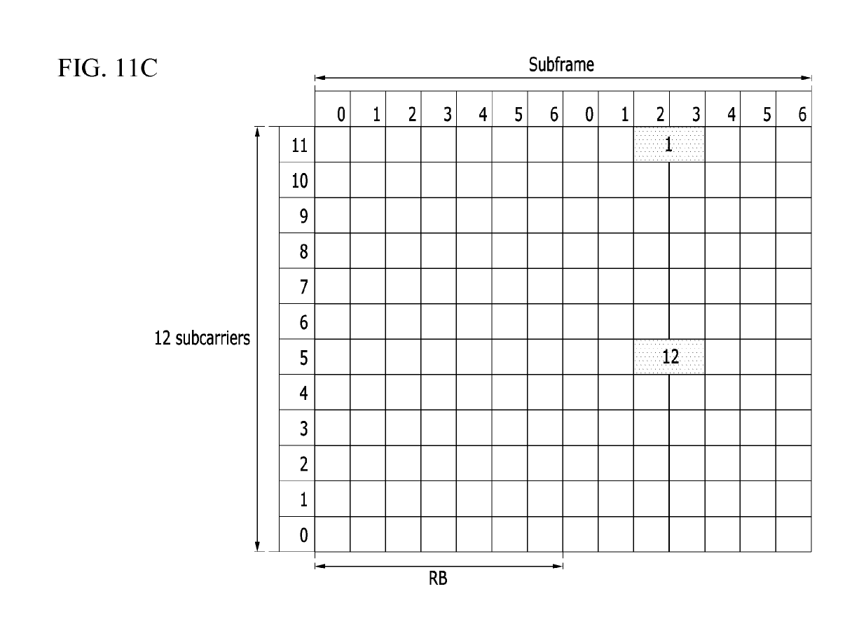

The macro cell 200 may configure an RE for RSSI measurement (hereinafter referred to as an “RRC measurement RE”) for each terminal 100 through RRC signaling. The terminal 100 may measure an RSSI in the RSSI measurement RE. In detail, the terminal 100 may arithmetically average strength of received signals measured in each RSSI measurement RE. The serving cell (e.g., 200) may configure every RE transmitted by a plurality of small cells 301, as the RSSI measurement RE for the terminal 100. To ensure accuracy of measurement, the RSSI measurement RE may include at least two REs in the frequency axis. For example, when the RSSI measurement RE is configured to include a CSI-interference measurement (IM) and a CSI-RS, the RSSI measurement RE may include two or more REs in the frequency axis. A CSI-RS subframe that each small cell 301 may have when three small cells 301 are deployed will be described in detail with reference to FIGS. 11A, 11B, and 11C.

FIGS. 11A, 11B, and 11C are views illustrating CSI-RS subframes for a small cell when a received signal strength indicator (RSSI) is measured in units of resource elements (REs) according to an exemplary embodiment of the present invention.

In a case in which three small cells 301 in a dormant DTx state are deployed, the macro cell 200 may configure a CSI-RS subframe as illustrated in FIGS. 11A, 11B, and 11C. In detail, FIG. 11A illustrates a CSI-RS subframe for a third small cell 301 in a dormant DTx state, in which CSI-RS resources {0, 10} are configured. FIG. 11B illustrates a CSI-RS subframe for a fourth small cell 301 in a dormant DTx state, in which CSI-RS resources {4, 11} are configured. FIG. 11C illustrates a CSI-RS subframe for a fifth small cell 301 in a dormant DTx state, in which CSI-RS resources {1, 12} are configured.

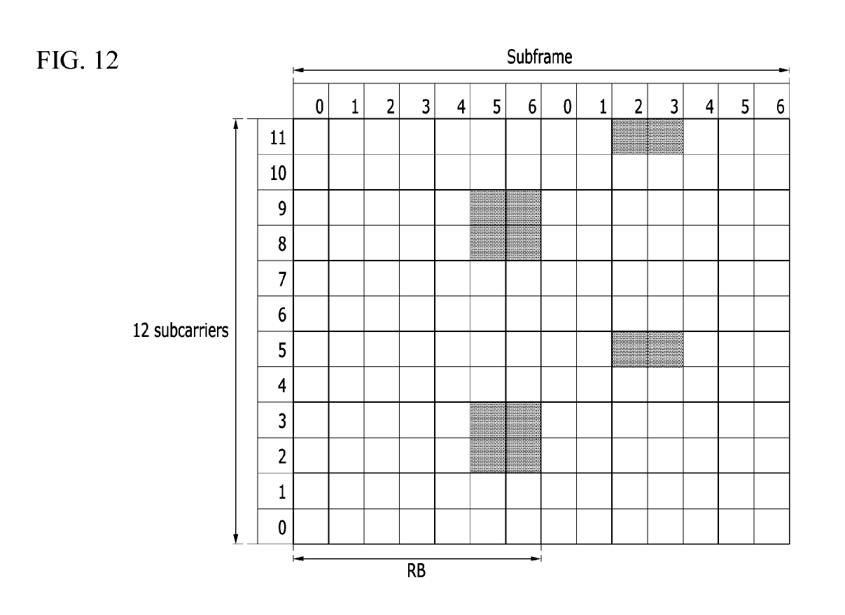

RSSI measurement RE configured to the terminal 100 will be described in detail with reference to FIG. 12.

FIG. 12 is a view illustrating RSSI measurement REs for a terminal when RSSI is measured in units of REs according to an exemplary embodiment of the present invention. In detail, FIG. 12 illustrates an example of an RSSI measurement RE that may be configured by the macro cell 200 for the terminal 100.

The macro cell 200 may configure an RSSI measurement RE for the terminal 100. Here, the RSSI measurement RE may include all the CSI-RSs configured in all the small cells (e.g., the third to fifth small cells 301 in FIGS. 11A through 11C). For example, when the three small cells 301 are deployed as illustrated in FIGS. 11A through 11C, the RSSI measurement RE may include the CSI-RS resources {0, 1, 4, 10, 11, 12} illustrated in FIGS. 11A through 11C.

The terminal 100 may derive an RSSI by arithmetically averaging power of all the components received in each RSSI measurement RE. Since all the small cells 301 of FIGS. 11A through 11C are in the dormant DTx state, the terminal 100 may receive a signal only from a single small cell 301 in each RSSI measurement RE. In order to calculate an RSSI, the terminal 100 may arithmetically average all of the power values received in the RSSI measurement REs.

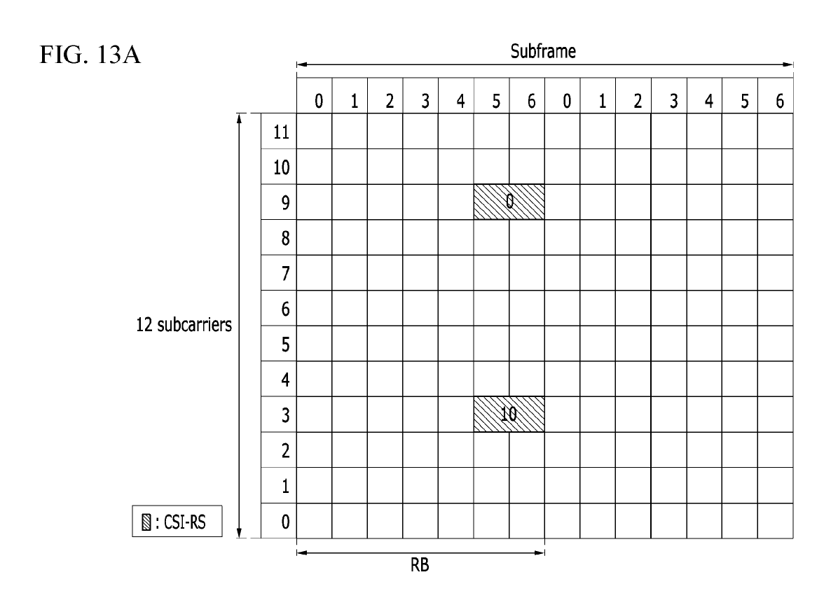

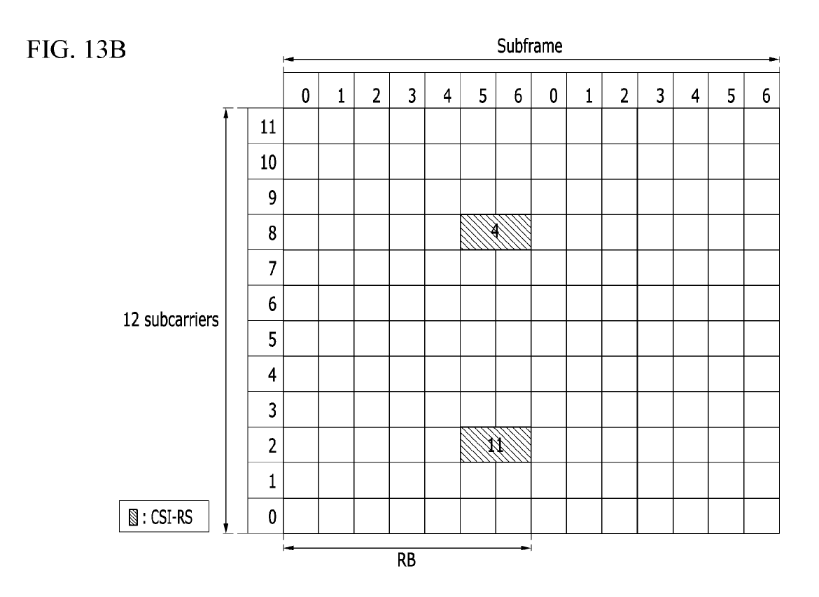

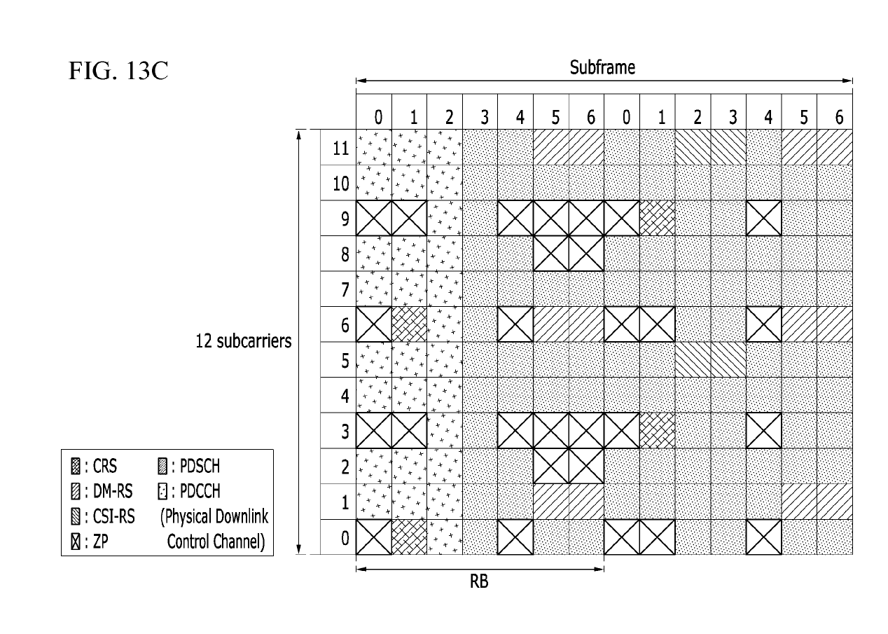

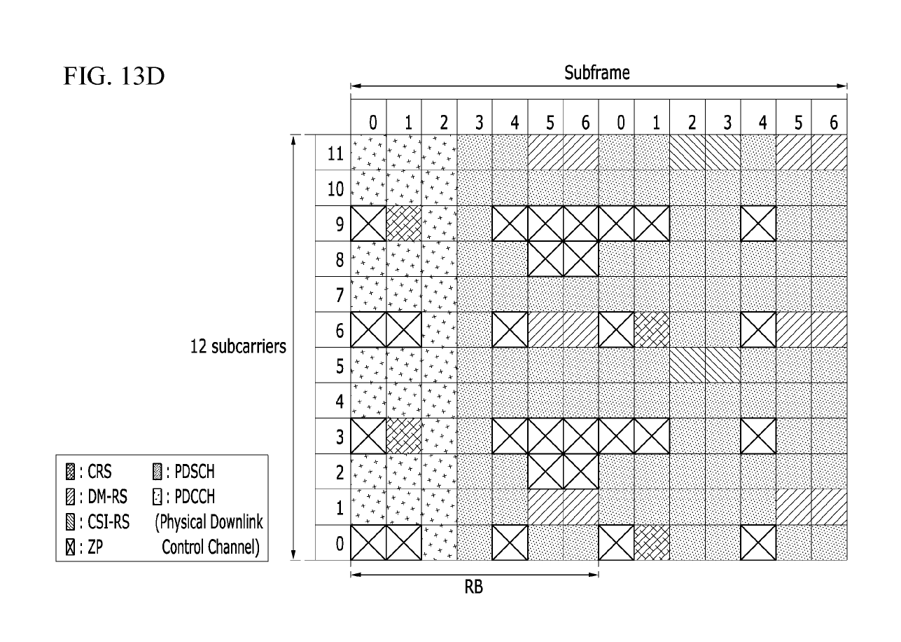

Meanwhile, a CSI-RS subframe that each small cell 301 may have when a portion of the deployed small cells 301 is in an active state will be described in detail with reference to FIGS. 13A through 13D.

FIGS. 13A, 13B, 13C, and 13D are views illustrating CSI-RS subframes for a small cell in a dormant state and a small cell in an active state when an RSSI is measured in units of REs according to an exemplary embodiment of the present invention. In detail, FIGS. 13A through 13D illustrate a case in which two small cells 301 among the three deployed small cells 301 are in a dormant DTx state, and the other remaining small cell 301 is in an active state.

FIG. 13A illustrates a case in which the third small cell 301 of FIG. 11A is in a dormant DTx state, and FIG. 13B illustrates a case in which the fourth small cell 301 of FIG. 11B is in a dormant DTx state. In detail, FIG. 13A illustrates an example of a CSI-RS subframe for the third small cell 301 in the dormant DTx state, and FIG. 13B illustrates an example of a CSI-RS subframe for the fourth small cell in the dormant DTx state.

FIGS. 13C and 13D illustrate a case in which the fifth small cell 301 is in an active state and the fifth small cell 301 allocates a PDSCH by using two antenna ports. In detail, FIG. 13C illustrates an example of a CSI-RS subframe for an antenna port used by the fifth small cell 301 in an active state, and FIG. 13D illustrates an example of a CSI-RS subframe for the other remaining antenna port used by the fifth small cell 301

The fifth small cell 301 may configure a ZP CSI-RS in order to not interfere with the third small cell 301 and the fourth small cell 301. In detail, the fifth small cell 301 may configure ZP CSI-RSs for a resource corresponding to a subcarrier #9 with respect to OFDM symbols #5 and #6, a resource corresponding to a subcarrier #3 with respect to the OFDM symbols #5 and #6, a resource corresponding to a subcarrier #8 with respect to the OFDM symbols #5 and #6, and a resource corresponding to a subcarrier #2 with respect to the OFDM symbols #5 and #6. The fifth small cell 301 may not allocate a PDSCH for a resource in which the ZP CSI-RS has been configured. In the case of the FIGS. 13A through 13D, an RSSI may be measured in the same manner as or in a manner similar to those of FIGS. 11A through 11C and FIG. 12.

Meanwhile, in the case of the FIGS. 13A through 13D, an RSSI measurement RE for the terminal 100 may be configured as illustrated in FIG. 12. The terminal 100 may measure an RSSI by using an RSSI measurement RE. In order to measure an RSSI, the terminal 100 may arithmetically average all of powers received in each RSSI measurement RE.

As described above, in order to configure an RSSI measurement RE, the serving cell (e.g., 20) may perform RRC signaling for each terminal 100. The terminal 100 may measure an RSSI by arithmetically averaging powers received in the RSSI measurement RE configured according to RRC signaling. The terminal 100 may report the measured RSSI value to the serving cell (e.g., 200).

Meanwhile, in a case in which a cell discovery signal is configured based on a CSI-RS, the RSSI measurement RE may be configured for the terminal 100 in the same manner as that of the CSI-IM. The terminal 100 may measure an RSSI only in the configured RSSI measurement RE.

### 5-3. Method of Measuring CSI-RS-Based SINR and Method of Estimating CQI

The serving cell (e.g., 200) may configure an RE for measuring a signal-to-interference-plus-noise ratio (SINR) (hereinafter referred to as an “SINR measurement RE”) for the terminal 100. The SINR measurement method may use a method (e.g., a CSI-IM resource configuration or the like.) similar to a CSI measurement method proposed in the existing LTE standard. In order to measure an SINR, the following two methods (a first measuring method and a second measuring method) may be considered.

In case of using the first measuring method, the terminal 100 may report an interference measurement value in the form of an RSSI (scheme similar to the RSSI reporting scheme) to the serving cell (e.g., 200). In detail, the terminal 100 may measure a signal component by using a CSI RSRP of the serving cell (e.g., 200). The terminal 100 may measure an interference component in the SINR measurement RE. For example, in order to measure an interference component, a method similar to an RSSI measuring method proposed in the existing LTE standard or the foregoing 5-2. CSI-RS-based RSRQ measuring method may be used.

The terminal 100 may report the signal component (e.g., the CSI RSRP) and the interference measurement value measured in the SINR measurement RE to the serving cell (e.g., 200).

The serving cell (e.g., 200) may estimate an SINR based on the CSI RSRP and the interference measurement value reported from the terminal 100.

Meanwhile, in case of using the second measuring method, the terminal 100 may directly measure an SINR and report the measured SINR in the form of a CQI to the serving cell (e.g., 200). In detail, the terminal 100 may define an SINR in every SINR measurement RE as expressed by Equation 2 below.

$$SINR ( f , t ) = \frac{S ( f , t )}{I ( f , t ) + N ( f , t )} \qquad ( Equation 2 )$$

Here, considered SINR measurement REs correspond to an OFDM subcarrier index f and an OFDM symbol index t. S(f,t), I(f,t), and N(f,t) denote power of a signal, power of interference, and power of noise, respectively.

In order to increase measurement accuracy and cancel out a fading effect, the terminal may calculate an arithmetic mean value for every SINR(f,t). In this case, the terminal 100 may calculate a mean value in the full band or a mean value in the full band and a predetermined time domain.

The terminal 100 may report the calculated SINR estimate value (arithmetic mean value) in the form of a CQI to the serving cell (e.g., 200). In detail, the terminal 100 may assume that a BS (e.g., a small BS corresponding to the small cell 301) transmits a single codeword by using the full band (e.g., Set S defined in the current standard). The terminal 100 may derive a CQI (e.g., a CQI with respect to a link between the terminal 100 and the small cell 301) based on the assumption. Here, the Set S sub-band may denote a band considered when the terminal 1000 performs feedback. Namely, the terminal 100 may report the SINR estimate value to the serving cell (e.g., 200) according to a scheme similar to the broadband CQI report scheme defined in the current standard.

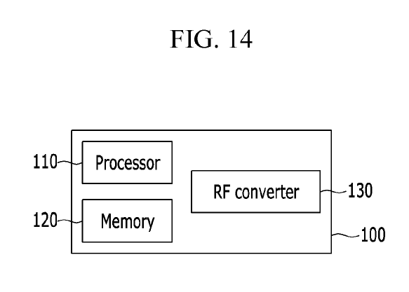

FIG. 14 is a view illustrating a configuration of a terminal 100 according to an exemplary embodiment of the present invention.

The terminal 100 includes a processor 110, a memory 120, and a radio frequency (RF) converter 130.

The processor 110 may be configured to implement the procedures, functions, and methods related to the terminal 100 described above with reference to FIGS. 1 through 12 and FIGS. 13A through 13D.

The memory 120 is connected to the processor 110 and stores various types of information related to operations of the processor 110.

The RF converter 130 is connected to the processor 110 and transmits or receives a radio signal. The terminal 100 may have a single antenna or multiple antennas.

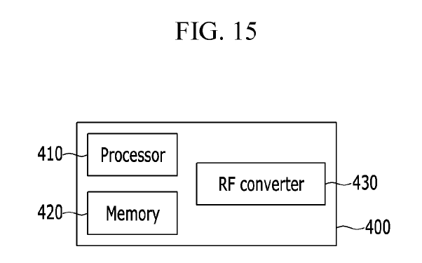

FIG. 15 is a view illustrating a configuration of a macro base station (BS) 400 corresponding to a macro cell 200 according to an exemplary embodiment of the present invention.

The macro BS 400 includes a processor 410, a memory 420, and a radio frequency (RF) converter 430.

The processor 410 may be configured to implement the procedures, functions, and methods related to the macro cell 200 described above with reference to FIGS. 1 through 12 and FIGS. 13A through 13D.

The memory 420 is connected to the processor 410 and stores various types of information related to operations of the processor 410.

The RF converter 430 is connected to the processor 410 and transmits or receives a radio signal. The macro BS 400 may have a single antenna or multiple antennas.

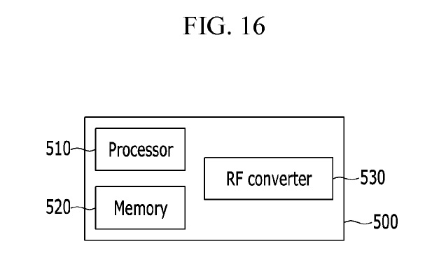

FIG. 16 is a view illustrating a configuration of a small BS 500 corresponding to a small cell 301 according to an exemplary embodiment of the present invention.

The small BS 500 includes a processor 510, a memory 520, and a radio frequency (RF) converter 530.

The processor 510 may be configured to implement the procedures, functions, and methods related to the small cell 301 described above with reference to FIGS. 1 through 12 and FIGS. 13A through 13D.

The memory 520 is connected to the processor 510 and stores various types of information related to operations of the processor 510.

The RF converter 530 is connected to the processor 510 and transmits or receives a radio signal. The small BS 500 may have a single antenna or multiple antennas.

Embodiments of the present invention provide a method and apparatus for cell discovery for an LTE mobile communication system. In detail, embodiments of the present invention provide a method and apparatus for cell discovery using a channel state information (CSI)-reference signal (RS) or an improved CSI-RS.

According to an embodiment of the present invention, a large number of small cells can be detected within a short time.

Also, according to an embodiment of the present invention, power of a small cell consumed for cell discovery can be minimized.

Also, according to an embodiment of the present invention, quality of a radio link (for example, reference signal received power (RSRP), reference signal received quality (RSRQ), etc.) can be more accurately measured.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for cell discovery of a terminal, the method comprising
measuring quality of a radio link by using at least one first orthogonal frequency division multiplexing (OFDM) symbol among OFDM symbols excluding an OFDM symbol including a channel state information (CSI)-reference signal (RS),
wherein the CSI-RS is used as a cell discovery signal.

2. The method of claim 1, further comprising
reporting the measured quality of the radio link to a serving cell.

3. The method of claim 1, further comprising
receiving, from a serving cell, first information including a period of a first subframe for measurement of quality of a radio link, an offset of the first subframe, and an index of the first OFDM symbol in the first subframe.

4. The method of claim 3, wherein the measuring comprises measuring a received signal strength indicator (RSSI) in the first subframe based on the first information.

5. The method of claim 4, wherein a physical downlink shared channel (PDSCH) or a demodulation (DM)-RS is configured in the first OFDM symbol.

6. A method for cell discovery of a terminal, the method comprising:
receiving configuration information of a channel state information (CSI)-reference signal (RS) from a serving cell through radio resource control (RRC) signaling;
determining a plurality of first subframes that are consecutive based on the CSI-RS configuration information;
receiving the CSI-RS from a plurality of cells adjacent to the terminal by using the plurality of first subframes; and
measuring quality of a radio link by using the CSI-RS.

7. The method of claim 6, wherein the CSI-RS configuration information comprises a period of the first subframe, an offset of the first subframe, and the number of consecutive first subframes.

8. The method of claim 7, wherein the CSI-RS comprises at least one among zero power (ZP) CSI-RS and non-ZP (NZP) CSI-RS.

9. The method of claim 8, wherein
the CSI-RS configuration information further comprises the number of first antenna ports for transmitting and receiving the ZP CSI-RS,
the CSI-RS configuration information further comprises a position of a first resource for transmitting and receiving the ZP CSI-RS in the first subframe, and
the receiving of a CSI-RS comprises determining the position of the first resource in the first subframe based on the CSI-RS configuration information.

10. The method of claim 9, wherein the number of resource elements that the first resource occupies in the first subframe is two when the number of first antenna ports for the first subframe is one or two.

11. The method of claim 8, wherein
the CSI-RS configuration information further comprises the number of first resources for transmitting and receiving the NZP CSI-RS, and
the receiving of a CSI-RS comprises determining the number of first resources in the first subframe based on the CSI-RS configuration information.

12. The method of claim 11, wherein a period of the first subframe and a period of a second subframe in which the CSI-RS is transmitted and received are different.

13. The method of claim 11, wherein
the measuring of quality of a radio link comprises:
measuring radio resource measurement (RRM) by using the first resource; and
measuring a CSI by using the first resource.

14. The method of claim 11, wherein
the measuring of quality of a radio link comprises:
measuring radio resource measurement (RRM) by using the first resource; and
measuring a CSI by using a second resource different from the first resource,
wherein the second resource is a resource for transmitting and receiving the NZP CSI-RS.

15. The method of claim 8, wherein
the CSI-RS configuration information further comprises the number of first antenna ports for transmitting and receiving the NZP CSI-RS, and
when the number of the first antenna ports is plural, the plurality of first antenna ports use the same OFDM symbol and different subcarriers in the first subframe.

16. The method of claim 8, wherein
the measuring of quality of a radio link comprises measuring radio resource measurement (RRM) by using a weight value used for code division multiplexing (CDM), and
the weight value for two resource elements (REs) is either [1, 0] or [0, 1].

17. The method of claim 8, wherein a period of the first subframe is one among 160 ms, 320 ms, 640 ms, and 1280 ms.

18. The method of claim 8, wherein
the measuring of quality of a radio link comprises measuring a received signal strength indicator (RSSI) by using a plurality of first resources of the first subframe, and
the plurality of first resources comprise all the resources for receiving the CSI-RSs from the plurality of adjacent cells.

19. The method of claim 8, further comprising
reporting the measured quality of the radio link to the serving cell,
wherein the measuring of quality of a radio link comprises:
calculating a signal-to-interference-plus-noise ratio (SINR) of each resource by using Equation 1 below; and
calculating an arithmetic mean value of the calculated SINR:
$$SINR ( f , t ) = \frac{S ( f , t )}{I ( f , t ) + N ( f , t )} \qquad [ Equation 1 ]$$
wherein f denotes an OFDM subcarrier index, t denotes an OFDM symbol index, S(f,t) denotes measured signal power, I(f,t) denotes measured power of interference, and N(f,t) denotes measured noise power.

20. The method of claim 11, wherein
the measuring of quality of a radio link comprises,
when the first resource and a second resource for transmitting and receiving the NZP CRI-RS exist in the same first subframe, measuring radio resource measurement (RRM) and CSI by using both the first resource and the second resource.

21. A method for cell discovery of a serving cell, the method comprising:
including the number of first antenna ports for transmitting and receiving a zero power (ZP) channel state information (CSI)-reference signal (RS) in configuration information of a CSI-RS used as a cell discovery signal;
when the number of the first antenna ports is two or less, including a position of a first resource for transmitting and receiving the ZP CSI-RS in the CSI-RS configuration information;
transmitting the CSI-RS configuration information to a terminal through radio resource control (RRC) signaling; and
receiving quality of a radio link measured by the terminal from the terminal.

22. A method of measuring radio resource measurement (RRM) by a terminal, the method comprising:
measuring reference signal received power (RSRP) by using a resource for a channel state information (CSI)-reference signal (RS); and
reporting the measured RSRP to a serving cell.

23. The method of claim 22, further comprising:
measuring a received signal strength indicator (RSSI) by using an orthogonal frequency division multiplexing (OFDM) symbol not including a CSI-RS;
measuring reference signal received quality (RSRQ) by using the RSRP and the RSSI; and
reporting the measured RSRQ to the serving cell.
